(19) United States
(12) Patent Application Publication
(10) Pub. No.: US 2013/0073309 A1
(43) Pub. Date: Mar. 21, 2013

(54) CUSTOMIZABLE PAYMENT SYSTEM AND METHOD

(71) Applicant: PAYSPAN, INC., Jacksonville, FL (US)

(72) Inventor: Brian L. Ritchie, Jacksonville, FL (US)

(73) Assignee: PAYSPAN, INC., Jacksonville, FL (US)

(21) Appl. No.: 13/674,721

(22) Filed: Nov. 12, 2012

Related U.S. Application Data
(63) Continuation-in-part of application No. 12/816,896, filed on Jun. 16, 2010, now abandoned.
Application No. 12/816,896 is a continuation of application No. 11/352,407, filed on Feb. 13, 2006, now abandoned.
(60) Provisional application No. 60/651,626, filed on Feb. 11, 2005.

(51) Int. Cl. G06Q 50/22

(52) U.S. Cl. 705/2

(57) ABSTRACT

A system and method facilitates secure payments to a payee, according to custom preferences of the payee. The system is offered by the payer (as opposed to the biller) using a third party and, a payee can enroll with a customized account processing center (CAPC), which is the third party. The CAPC captures and stores payment information about the payee from the payer and payee. The payee registers preferences for funds deposit and also the payee's preferred remittance format. When a payee is registered and elects payment via electronic funds transfer, the CAPC issues instructions to the bank to transfer funds from the payer's bank account to the payee's registered preferred bank account. The CAPC can also create a detailed record of payment histories and remittance details which are accessible to the payee. Remittance details are delivered in the payee's registered preferred format and routed to the payee's registered destination.

### CROSS REFERENCE TO RELATED APPLICATION

This application claims priority under to co-pending U.S. patent application Ser. No. 12/816,896 filed on Jun. 16, 2010, which claims the benefit of priority to U.S. patent application Ser. No. 11/352,407, which, in turn, claims the benefit of priority to U.S. Provisional Application No. 60/651,626 filed on Feb. 11, 2005, the disclosure of each of which is incorporated herein by reference in their entireties.

### FIELD OF THE INVENTION

Embodiments of the invention relates to a system and method for electronic payment, and more particularly for a system and method that facilitates centralized payments and payment decisioning offered by the payer (as opposed to the biller) through a third party.

### DESCRIPTION OF RELATED ART

Conventional systems and methods for billing and payment are generally paper intensive whereby bills are printed on paper and payment is made by a paper instrument, such as a check. These conventional methods for billing and payment are not optimal for several reasons, including, the excessive time that may be required for delivering and processing physical documents, as well as overhead costs involved with delivering physical documents, such as the cost of postage or a private delivery service and the personnel necessary to administer the handling of such documents. These conventional billing and payment methods are also cumbersome due to the need for complex record keeping and the need to store large quantities of paper records. The difficulties in maintaining proper record keeping and accounting are further exacerbated for those business entities that process large amounts of billing (such as invoices) and payments (such as checks) from numerous and diverse entities.

The incorporation of electronic systems and methods for the dissemination and collection of invoices and payments has become increasingly common over the last several years. Initially, such electronic transfers existed primarily between banks, with the introduction of electronic funds transfers through systems such as the automated clearing house. More recently, non-banking entities, including individual consumers, are increasingly taking advantage of the increased efficiencies of electronic payment systems.

The payment methods associated with the health care industry have additional nuances that are specific to that industry. A hospital or other health care provider (such as a doctor, clinic, or laboratory technician) typically may bill a patient's insurance company at a list price for the services rendered to a patient. If the patient is insured, the insurance company will determine the price contracted for that particular service that will be paid to the health care provider based upon the terms of the patient's insurance plan and/or the terms of existing agreements between the insurance company and the health care provider. The insurance company will then issue payment, typically a paper check, to the health care provider along with an explanation of payment (EOP). The EOP may explain the basis for the amount of payment made to the health care provider. The health care provider does not usually receive full payment of the list price and will often have to write-off the amount of the underpayment. However, because of the delay that often results between the sending of invoices from the health care provider to the insurance company, the processing of invoices at the insurance company and the sending of payment from the insurance company to the health care provider, these write-offs often occur later in time which may delay the posting of the payment on the provider's books, thus interfering with prompt accounting. More importantly, health care providers typically must submit invoices to a myriad of insurance companies (given that the different patients they serve are often enrolled with various insurance companies). Because insurance companies may employ differing formats for the explanation of payments that may accompany payment, health care providers have an additional administrative burden. Thus, the conventional billing and payment methodologies can be even more burdensome in certain industries, such as the health care industry.

### SUMMARY OF THE INVENTION

The present invention provides system and method for business entities (including health care entities) to efficiently disburse, manage, record or disseminate, payments, payment information, and associated information. Although reference is made to business entities, the present invention is equally applicable to non-profit or government institutions, or any entities in which financial obligations are incurred or financial receivables are obtained.

Business entities typically have prior, current, and potential (future) obligations as well as previous, current and potential (future) receivables (amounts owed, owing, or to be owed by other entities to the business entity). To handle the transfer, disbursement and dissemination of billing information (including invoices), payments, payment information, and associated information, the invention provides a customized account processing center (CAPC).

In accordance with the invention, a business entity may register with the CAPC in order to establish particular customized procedures and practices by which the CAPC will facilitate payments by the business entity to various payees. Thus, the CAPC acts as an agent for the payer in order to facilitate payment. These procedures and practices will typically be contained as terms in a customized account processing agreement executed between the business entity and the CAPC. If the CAPC is facilitating payments by the business entity to a payee, the agreement may include terms limiting the maximum disbursement that may be made by the CAPC in any one payment, the cumulative maximum payments the CAPC may authorize over a given period of time, the record keeping or accounting obligations of the CAPC, the circumstances under which the CAPC is authorized to make payments, including the method for authenticating the business entity's authorization for payment, and the disclosure of the financial structure and relationship between the business entity and CAPC (the account numbers to be used by CAPC in making payments). When the CAPC is facilitating payment to a payee, the terms of the customized account processing agreement may include terms directing the disposition of payments received (such as automatic electronic fund transfers to particular accounts or the crediting of accounts held by CAPC—either internally within CAPC or externally with other entities—for payments received by the CAPC on behalf of the business entity as payee), the handling and formatting of payment information, and the handling and formatting of associated information, including such information required to facilitate payments. The terms of the customized account processing agreement and the customized functions performed by the CAPC will typically be based upon the particular requirements, strategies and structure of the business entity.

One feature of the present invention is the delivery of a custom-formatted payment, custom-formatted payment information and custom-formatted associated information to business entities (which may be acting in capacities as either payees or payers, or both payees and payers).

Payment may refer to the transfer of value from one entity to another and may be done by numerous methods such as checks, cash, electronic fund transfers, the crediting of internal or external accounts held by any entity. Payment information may include information identifying the payer, payee, amount of payment, date for payment, and the like. Associated information may include miscellaneous information regarding the reasons for a particular amount of payment (in the case of health care industry, for example, this may be an explanation of payment), comments, suggestions, complaints, or any other information deemed appropriate by a party with whom the associated information is concerned.

In accordance with one embodiment of the invention, the CAPC handles payment to payees for the business entity (when the business entity would normally be acting in the capacity of a payer). In accordance with the invention, a business entity may provide to the CAPC payment information, its own account information and authorization across a secure communication channel. Although this secure communication channel may be a dedicated communication channel between the business entity and the CAPC, it is generally more cost effective and convenient for such information to be securely exchanged over public networks using trust-worthy encryption techniques, which are commonly available on the open market and may be readily purchased. Once the CAPC receives the payment information and authorization from the business entity, the CAPC may act in accordance with a customized account processing agreement that was entered into between the business entity and the CAPC. This agreement may direct how the payee is to receive the funds. If the payee is registered with the CAPC, the CAPC will act in accordance with an customized account processing agreement entered into between the payee and the CAPC. Thus, the CAPC facilitates payment to the payee by accessing the business entities (payer's) account to transfer payment to the payee in the form of a check or by electronic payment.

In accordance with an embodiment of the invention, in the instances where the payee is not enrolled and/or registered with the CAPC, the payment may take the form of a physical check which may be printed and mailed by the CAPC to the payee. The invention also provides that the CAPC may direct an invitation to the payee to register with the CAPC. The invitation may include a link to a secure website for registering with the CAPC. The invitation may notify the payee that he or she may register with the CAPC so that future payments can be made electronically and can be made by the CAPC in a custom-format to the payee's specification (such as immediate deposit into particular accounts). Additionally, the payee may be informed that registration with the CAPC will allow the custom-formatting of associated information that may accompany payment. Given that the associated information may come in different formats from different payers (such as insurance companies' use of different formats for the explanation of payment), custom-formatting performed by the CAPC on behalf of the payee may further simplify the administrative handling of the payment collection, including accounting and record keeping.

As described above, one approach for informing the payee of the beneficial services offered by the CAPC is to provide the unenrolled/unregistered payee with such information in a separate mailing, telephone solicitation or electronic message to the payee (although telephone solicitation may be restricted by applicable laws, it is notable that there is an existing business nexus between the CAPC and the payee, as the payment made to and presumably accepted by the payee originates from the CAPC). This has the beneficial effect of informing the payee of the availability of the CAPC's services through a trustworthy manner as the invitation is directed by the CAPC or a third party authorized by the CAPC. Moreover, this method is particularly well-suited and may be preferred over other advertising methods as it is directed targeted to only those parties who are eligible to use the services offered by a CAPC.

In accordance with an embodiment of the invention, the method by which the payee is invited to register may be facilitated by the inclusion of a reserved registration code that the CAPC associates with the payee. The payee may utilize this registration code to register with the CAPC via the Internet (most likely through a secure website), by telephone, by mail, or by any other practicable means.

Payees may receive payments from multiple payers, with each payer potentially using a different format for the delivery of payment, payment information, and associated information. The system in accordance with the invention allows convergence of these different sources and formats of payment, as well as the different sources and formats of associated information into a consistent format with easily accessible record keeping and a centralized source for the presentation of information regarding payments. The invention allows payees to increase their operating efficiency through to standardization of the myriad of information and payments into a uniform format best suited to its own operations.

Although as used herein, a payer typically has a financial obligation to a payee and makes payment to the payee, it is easily foreseeable that parties may be mutually obligated and that parties may simultaneously be deemed a payer and a payee.

In accordance with the invention, payees may register or enroll with the CAPC through their own initiative and payees may enroll at the behest of a payer with whom the payees interacts. Thus, payers may take advantage of the present invention regardless of whether any payees are registered with the CAPC. If the payee is not registered with the CAPC, a paper check is issued in the same fashion as payments are typically issued.

Thus, the invention provides a centralized payment processing system that allows multiple payees and payers to join. The system in accordance with the invention verifies that the payees and payers are the proper parties to the payment transaction in order to prevent errors and/or fraudulent transactions. The system in accordance with the invention also creates a record of payments and related information that is viewable by payees. This allows payees to verify and reconcile received payments against outstanding invoices, resulting in fewer misapplications of payments to their related invoices. The system in accordance with the invention also provides for electronic notification to payees of payments received. The system in accordance with the invention also facilitates payments to payees not enrolled in the centralized payments processing system and notifies them of the opportunity to enroll in the system.

Depending on particular configuration of the embodiment of the present invention, benefits that may be achieved in embodiments of the present invention include: [0020] More rapid disbursement of payments; [0021] Customized delivery of payments and associated information; [0022] Simplified accounting, record keeping, and management of payment; [0023] Increased cost efficiency by reducing administrative and operating costs; [0024] Improved fraud detection and decrease in processing errors by the creation of more uniform information presentation and handling; [0025] A more secure and consistent method of payment by elimination of distribution through the postal or other mail or package delivery service; [0026] Confirmation to payees of payments received by electronic means or other reliable methodologies; [0027] Batch enrollment of multiple payees and payers within a common payment system; [0028] Archiving of all payment histories, the archives being viewable by payees; and [0029] Verification that payees and payers are the proper parties.

### BRIEF DESCRIPTION OF THE DRAWINGS

FIG. 1 shows a block diagram of an embodiment of the invention illustrating the payer, a payee and a customized account processing center for facilitating payments in accordance one embodiment;

FIG. 2 shows a block diagram of the system illustrated in FIG. 1 described in terms of the health care industry in accordance one embodiment;

FIG. 3 is a flowchart illustrating a process for facilitating payments utilizing the customized account processing center in accordance one embodiment;

FIG. 4 is a flowchart illustrating another process for facilitating payments utilizing the customized account processing center in accordance another embodiment; and

FIG. 5 illustrates a diagrammatic view of a database for housing claim data, payment data and payee data.

### DETAILED DESCRIPTION OF THE PREFERRED EMBODIMENTS

The invention disclosed herein may be beneficially applied to diverse business entities across numerous service and manufacturing industries such as the health care industry, the automotive industry, the food services industry, or any other manufacturing or service industries, such as the financial institutions associated with the payment process (including banks, credit unions, brokerages and insurance companies).

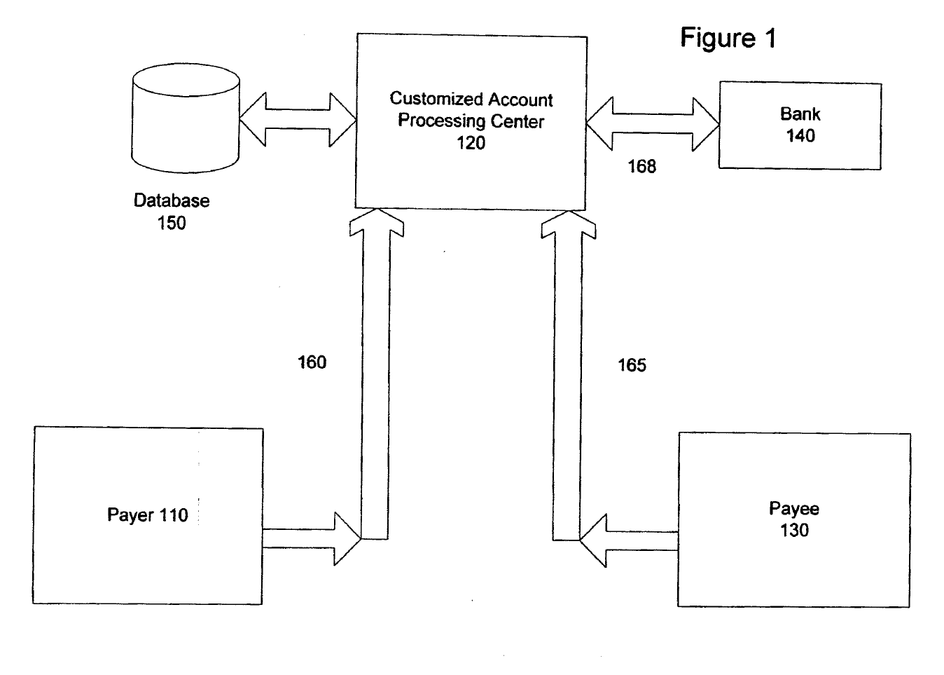

One embodiment of the invention is depicted in FIG. 1, FIG. 1 shows a payer 110 in communication via a link 160 with a customized account processing center (CAPC) 120. FIG. 1 also shows a bank or other financial institution 140 in communication via the link 168 with the CAPC 120. FIG. 1 also shows a payee 130 in communication via the link 165 with the CAPC 120. FIG. 1 also shows a database 150 which is accessible and communicatively coupled to the CAPC 120. It should be noted that the communication links 160, 165 and 168 can be any of a number of types communication channels, such as a local area network (LAN), a virtual private network (VPN) or the Internet. The database 150 is capable of storing a variety of information relating to payers and/or payees, such as account information, payment rules and formats, etc. In general, the system illustrated in FIG. 1 allows a plurality of payers to facilitate payments to a plurality of payees. As will be described in greater detail below, individual payees can enroll with the CAPC 120. By enrolling with the CAPC 120, the payee 130 is part of the CAPC 120 and can view archived records of payment histories. Thus, the payee 130 can review when payments were received and can take corrective action if there is a payment problem. Once enrolled, the payee 130 also has the option of registering with the CAPC 120. When the payee 130 registers with the CAPC 120, he or she can provide the CAPC 120 with their account number so that transactions can be made electronically. This also allows the payee 130 to view their account electronically. The payee 130 also receives an electronic notice from the CAPC 120 when a payment has been made. This puts the payee 130 on alert that a payment has been made. Concurrently, the CAPC 120 issues instructions to the bank 140 to transfer funds to the back account of the payee 130. A registered payee also has the ability to import payment details from the CAPC 120 in a custom format as may be selected by the payee 130. This allows the payee 130 determine which invoices are being paid at a particular time by the payer and results in less unallocated funds. The system also allows payee to post back into its account so that it can confirm what it is being paid for. The CAPC 120 also has functionality to verify that both the payer 105 and the payee 130 are the proper parties.

In operation, when a payer 110 receives an invoice from a payee 130 for goods or services, it can review and assess the received invoice and make a decision as to whether payment should be made. If a decision to make payment is made, the decision can be conveyed to the CAPC 120. If the payer 110 is new to the CAPC 120, then that payer can register with the CAPC 120 and provide certain information, such as the payer's account information at the bank and other payment details, such as specific times when to make payment. If the payer is already registered with the CAPC 120, then various information about the payer 110 may be stored in the database 150 and the CAPC 120 authenticates the payer 110 to confirm that he or she is the registered payer. By having this information which can be accessed as needed, errors that arise when information is re-keyed do not occur. A decision to make payment may include the amount to be paid, the payer's account information, along with additional information to be conveyed with the payment, such as an explanation of the payment. Once the CAPC 120 has received authorization to make payment for a payer 110, it authenticates both the payer 110 and the payee 130 to confirm that they are the proper parties, i.e., that the payee is the correct party to receive payments and the payer is the correct party to make payments. Then payments are made using the payer account information that is stored in the database 150. If the payee 130 is not enrolled and registered with the CAPC 120, then payment made be made in the form of a paper instrument, such as a check. However, if the payee 130 is enrolled and registered with the CAPC 120, then payment may be made in accordance with any existing settings by communicating with the bank 140 and issuing the necessary instructions to transfer funds electronically. For example, the payee 130 may have instructed the CAPC 120 to make payment electronically to a particular account number. Alternatively, the payee 130 may desire a paper check. Payment by a paper check is also the default payment setting when the CAPC 120 does not have any pre-existing data about the payee 130. The CAPC 120 sends a notice to the all registered payees when a payment has been made. This notice may be an electronic notification, such as an e-mail message.

The CAPC 120 stores a variety of payment records/histories. The CAPC 120 stores the entire payment history and records for all payments made to the payee 130 for a predetermined amount of time set by the payee. In one embodiment of the invention, an extended archive may be created which records every transaction for a payee since its enrollment with the CAPC. This log includes information about when payment was made, how much payment was made and what the payment was for. Those payees who are enrolled with the CAPC 120 have the ability to view these records. The CAPC 120 also allows payees to manage their accounts. The CAPC 120 allows registered payees to import payment details in a standard format that can be selected by the payee. Thus, at any time, the payee 130 can determine why certain funds were received and what they are directed to. This minimizes unnecessary accounts receivables on the records of the payees as they quickly can match received funds with the invoices they are intended for. Payees can then write-off any excess charges that the payers will not pay for.

In one embodiment of the invention, when payment is made via the CAPC 120 to a payee 130 and the payment is made by a paper check or by other non-electronic means, the CAPC 120 may send a separate invitation for the payee 130 to enroll and/or register with the CAPC 120 so that future payments may be made electronically. Alternatively, the CAPC 120 can request a third party to send such an invitation to enroll directly to the payee 130 and also to provide the electronic notice of payment received. Registering with the CAPC 120 will also allow payees to establish particular guidelines and standards for receiving payment, such as dates and times when payment is preferred, for example and if they wish to be notified when a payment is received.

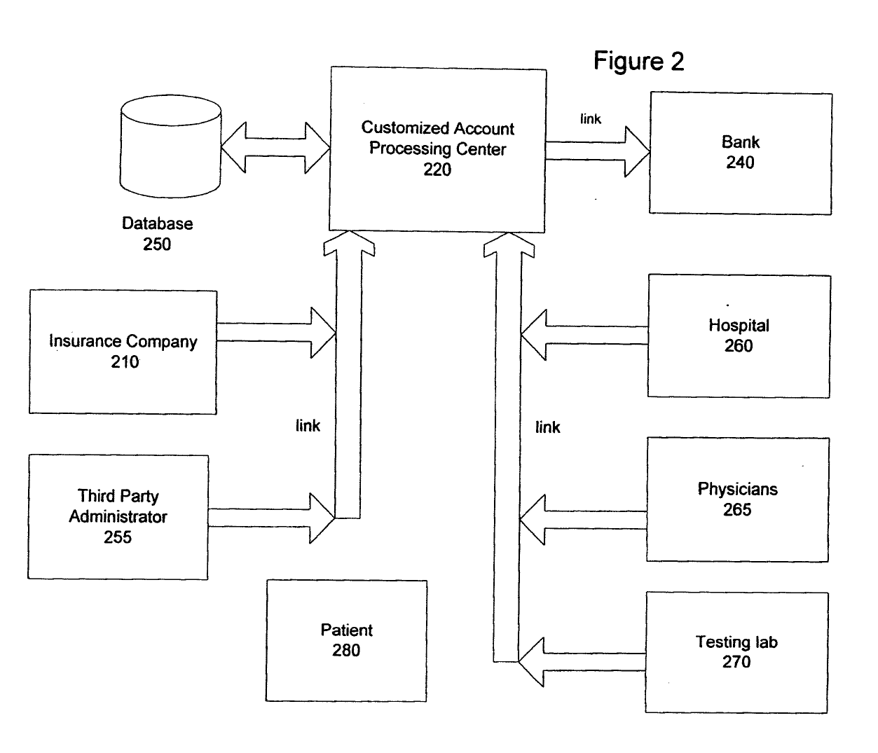

FIG. 2 describes the system in accordance with the invention in the context of the health care industry. FIG. 2 shows payers which include an insurance company 210 and a third administrator 255 that overseas a health plan, both of which act as payers and make payments for various health insurance claims. FIG. 2 also shows various health care providers, such as a hospital 260, group of physicians 265 and a testing lab 270 (collectively “health care providers” or “payees”). FIG. 2 also shows a bank or other financial institution 240 in communication with the CAPC 120. In this example, the health care providers 260, 265 and 270 deliver one or more services to a patient 280. The health care providers 260, 265 and 270 then generate an invoice for payment that is delivered to the insurance company 210 or their third party administrator 255. Upon receipt of the invoice, the payer's insurance company 210 or third party administrator will ascertain the nature of payment to be made to the payees. This will be based upon pre-negotiated rates between the insurance company 210 or third party administrator 255 and the health care providers 230. For example, although a hospital may bill $200 for an x-ray, the insurance company may have a pre-negotiated rate of $100 for such a service.

In accordance with the invention, the insurance company 210 and third party administrator 255 (“payers”) is registered with the CAPC 220 so that the CAPC 220 facilitates payments to the health care providers. The payees 210 and 255 can provide information about a variety of health care providers so that the CAPC 220 can facilitate payment to more than one health care provider. Upon determining the amount to be paid to the health care providers, the insurance company 210 or third party administrator 255 then notifies the CAPC 220 of the amount of payment to be directed to the health care providers. The CAPC 220 will determine whether the health care provider is enrolled and/or registered with the CAPC 220. If the health care provider is registered with the CAPC 220, then information relating to that health care provider, such as its account number as well as any other rules and conditions for making payment reside at the CAPC. The CAPC 220 then verifies that the payee and payer are then proper authorized parties and then payments can then be made to the health care providers. If the health care providers are known, such information will be stored in the CAPC's database 250. For registered users, the CAPC 220, can also access the terms and conditions for payment to the health care provider 230 and can make payment in accordance with those pre-existing terms and conditions. For example, the health care provider 230 may have instructions that payment must be made in paper form by check or alternatively electronically. If payment is to be made electronically, the CAPC 220 can issue instructions to the bank 240 to direct payment directly into that health care provider's bank account. If the health care provider is not enrolled or registered with the CAPC 220, then a paper payment, such as a check, is prepared and delivered to the health care provider. Those payees that are enrolled receive a notification, such as by electronic mail that payment has been received.

If the health care providers are enrolled with the CAPC 220, they will have access to the full payment histories and can view an archive of payments received. Registered health care providers can also import payment details from the CAPC 220 in a format that allows them to reconcile payments received with outstanding invoices.

In another embodiment of the present invention, the insurance company 210 or third party administrator 255 may be enrolled with the CAPC 220, while a particular health care provider to which the insurance company 220 or third party administrator 255 issues a payment is not enrolled. As invoices are submitted to the insurance company 210 by an unregistered health care provider and the corresponding payments are dispersed by the customized account processing center (after authorization from the insurance company), the customized account processing center may specifically and directly inform the unregistered health care provider (the payee) of the ability to register with the customized account processing center. This may be performed by providing a separate mailing, phone solicitation and/or e-mail notification on behalf of the insurance company 210 or third party administrator 255 to the health care provider. Thus, the system of the present invention can expand to include enrollees by specifically reaching them through a secure and direct approach.

Of course the embodiment above merely describes one sample embodiment of the invention within the health care industry of a small number of health care providers and a small number of insurance companies. It is expected that multiple health care providers and multiple insurance companies will advantageously use the present invention for their benefit. Indeed, a single patient may be associated with multiple insurance companies, thereby causing a health care provider to submit billing information to multiple insurance companies and subsequently receive multiple payments and multiple (often differing) explanation of benefits.

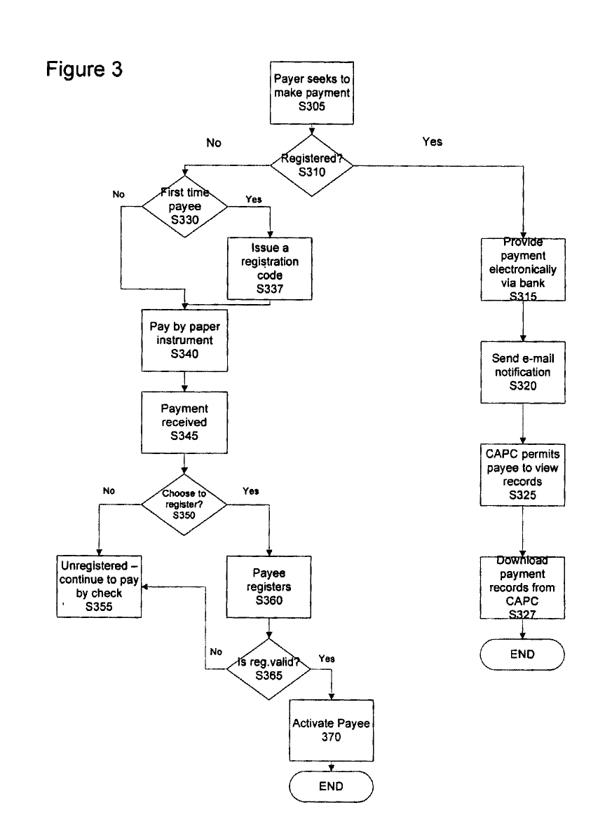

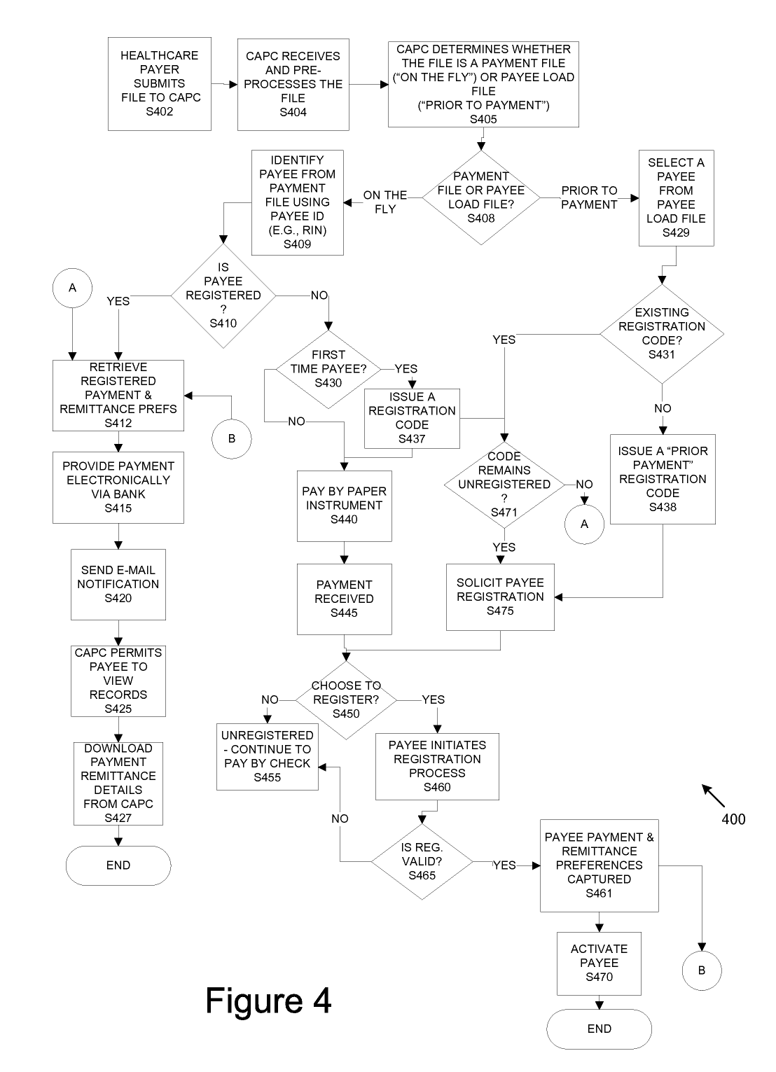

FIGS. 3-4 show process flows for the operation of the CAPC in accordance with embodiments of the invention. The processes of FIGS. 3-4 are directed to a payer (instead of a biller) offering to register a payee for payments and remittances with the payee with the intention of issuing payments according to the custom preferences of the payee, where the preferences are not simply electronic or paper-based payment. As such, the payer offers and/or initiates the registration for a third party entity (such as the CAPC). This third party, and not the payer, is the biller and processing entity.

FIGS. 3-4 therefore offers a solution for payers (e.g., healthcare payers) to offer customized reimbursement means to the payee and the third party (e.g., the CAPC) issues payment and remittance according to the combined instructions of issuance as expressed by both the payer and the payee and housed within the CAPC. The CAPC enables the payer to manage two distinct trading partner relationships with the payee: (1) the electronic payment (where payment is the EFT) relationship and details; and (2) the electronic remittance advice (ERA), where remittance is the data details of the payment associated with the EFT used by the payee to reconcile accounts receivable records. These custom payment and method capabilities within the CAPC are not present within healthcare claims adjudication systems. The CAPC is not a claims adjudication system, but is a customizable payment and method whereby payer and payee preferences are registered and managed by the CAPC, according to one embodiment.

FIG. 3 begins at step S305 in which a payer has determined that an amount of funds must be paid to a payee and submits authorization to the CAPC to make payment to a payee. If the payer is registered with the CAPC, the CAPC has prestored information about that payer, including his or her account number, as well as any other instructions regarding how payment should be made. The process then may move to step S310. In step S310, the CAPC determines whether the payee is enrolled and registered. If the payee is enrolled and registered, the method may proceed to step S315 where the CAPC provides payment to the payee in accordance with any instructions registered with the CAPC. These instructions may include when and where payment should be made, and whether such payments should be made electronically or by paper instrument such as a check. If payment is to be made electronically, account information is also registered with the CAPC. Thus, in step S315, payment is made in accordance with this pre-existing information. The process then may move to step S320 whereby a the CAPC sends a notification to the payee that a payment has been received. The process then may move to step S325. In step S325, the payee has access to view historical payment records and to also access information that will assist with reconciling the received payments with outstanding invoices. The process then goes to step S227 where the payee can download the payment history records. The process then ends.

Returning to step S310, if the payee is not registered with the CAPC, the method may proceed to step S330. In step S330, the CAPC determines whether the payee is a first time payee. If the payee not a first time payee, the method may proceed to step S340. If the payee is a first time payee, then the method may proceed to step S337 where the payee is issues a registration code and then the method may proceed to step S340. In step S340, the CAPC disburses the payment to the payee by a paper instrument, such as a check. As is described earlier, the CAPC may also separately send an invitation to register with the CAPC so that future payments may be made electronically. This invitation to register to the CAPC may include a link to a secure website for registering with the CAPC or other means for registering with the CAPC. The process then may move to step S345 where payment is now received by the payee and the payee also reviews the invitation to register with the CAPC. The process then may move to step S350 where the payee decides whether to register with the CAPC. If the payee decides to register with the CAPC, then the method may proceed to step S360; otherwise, the method may proceed to step S355. In step S355, where the payee has decided not to register with the CAPC, the payee will continue to receive checks or other paper payment instruments. Alternatively, in step S360 where the payee has decided to register with the CAPC, the payee then provides various information to the CAPC, such as account information and any other desired payment instructions and becomes registered. The process then may move to step S365 where the system determines whether the payee's registration code is valid. If the registration code is not valid, the method may proceed to step S355. If the registration code is valid, then the method may proceed to step S370 where the payee is activated and whereby future payments can be automated. The process then ends.

FIG. 4 illustrates another process for facilitating payments utilizing the customized account processing center in accordance another embodiment. FIG. 4 outlines two methods by which registration codes are issued and subsequently managed by the CAPC: (1)“On the Fly” Registration where registration codes can be issued in real-time as the payer's submitted file is processed and interrogated against the centralized database of registered payees. (2)“Prior to Payment” registration where codes can be issued on a periodic basis by the CAPC and is used when the payer expects to make a payment to payee(s) at some point in the future. Issuing codes prior to payment enables a pre-emptive enrollment process by which the payer can avoid the need to ever issue a payment in paper form to the payee. To issue registration codes prior to payment, the payer submits a payee load file to the CAPC. Both of the above methods are discussed below in FIG. 4.

FIG. 4 illustrates a process 400 for the operation of the CAPC in accordance with embodiments of the invention. Process 400 may begin at step S402, where the healthcare payer transmits electronically a file to the CAPC over a network. At step S404, the CAPC receives and preprocesses the file. Each file may be a payment file or a payee load file. The payment file may include information about the payee which the CAPC wishes to pay, such as the payee name, tax identification number (“TIN”), registration identification number (“RIN”), payee address or any other information about the payee or the claim to be paid. The payee load file may also include the same or similar data. The payment file has a different format and naming convention than the payee load file. For example, the payment file may have different contact as required by the CAPC as the payee load file and vice versa. Additionally, the payment file may have a specific naming convention than the payee load file. This allows the computers at the CAPC to identify the payment file and the payee load file as different files so they may be processed differently (i.e., either processed in the “on the fly” process or “prior to payment” process).

Regardless, preprocessing of the file occurs at step S404 as mentioned above and may include: the CAPC receiving (via an FTP transfer) and storing the file electronically, the CAPC parsing and validating the file, and the CAPC converting the file to a specific format (e.g., EDI, XML or a flat file). The received file may be validated by ensuring that certain information is contained in each file. If the file does not contain certain information, it is rejected and not processed further. For example, if the payee information in the payee file does not include a payee name and/or a RIN, the file may be rejected. The file is also converted from the current format to a format required by the CAPC, such as XML or EDI type files.

After pre-processing of the file has completed, process 400 continues to step S405, the CAPC determines whether the file is a payment file or a payee load file. This determination is completed by the CAPC processing the name of the file as well as determining the content of the file. If the file both meets the predetermined file naming convention and the content meets the predetermined content requirements, process 400 moves to step S408.

At S408, process 400 splits into two different processes based on whether the file is a payment file (indicating a current payment is being made) or a payee load file (indicating the payer wants the CAPC to get certain payees to pre-register for future payments). If the file is a payment file, process 400 proceeds to an “on the fly” process as started by step S409. If the file is a payee load file, process 400 proceeds to an “prior to payment” process as started by step S429.

In S409, the payee is identified by extracting the data from the file. Data is extracted from the file, such as the RIN. If the payee is registered with the CAPC, the CAPC has pre-stored information about that payee, including the payee's account number, as well as any other instructions regarding how payment should be made for the payee. The process then may move to step S410.

In step S410, the CAPC determines whether the payee is enrolled and registered. The CPAC may check the extracted RIN to the CAPC's database to determine if the RIN already exists in the database and if the payee has registered the registration code. If the RIN is found and the RIN is registered with the CAPC, the CAPC determines that the payee is registered. The process may then move to step S412 where the CAPC retrieves the payee's payment/remittance preferences or instructions to provide payment to the payee in accordance with any such preferences/instructions that have been pre-stored with the CAPC (as discussed later in S461). These preferences/instructions may include when and where payment should be made, and whether such payments should be made electronically or by paper instrument such as a check. If payment is to be made electronically, account information is also registered with the CAPC. Thus, in step S415, payment is made in accordance with the payee's pre-existing preferences and instructions.

Process 400 then may move to step S420 whereby the CAPC sends a notification to the payee that a payment has been received. Thereafter, in step S425, the payee has access to view historical payment records and to also access information that will assist with reconciling the received payments with outstanding invoices. Such access is provided by the CAPC at the database at the CAPC. The CAPC may also provide a user interface to facilitate such data access.

The process then may proceed to step S427 where the payee can download the payment history records from a database at the CAPC. The process then may end.

Returning back to step S410, if the payee is not registered with the CAPC, the method 400 may proceed to step S430. In step S430, the CAPC determines whether the payee is a first time payee. This determination is made by the CAPC querying the database to determine if the in the CAPC's database and whether an electronic or paper payment has been issued by the CAPC to the payee. If so, the payee is not a first time payee. If the payee is not a first time payee, the method may proceed to step S440.

If the payee is a first time payee, then the method 400 may proceed to step S437 where the payee is issued a registration code. The registration code utilized by the CAPC is a unique code that ties the payer and the payee together, linking the respective payment preferences of party to the disposition of the payment transactions processed by the CAPC. The registration code is based on a unique key, referred to as a Recipient Identification Number or “RIN.” The components of the RIN are customizable by the payer and are reflective of the particular way the payer sees its payees. The components utilized in the construction of the RIN provide the CAPC with the ability to issue a registration code representative of that unique payer-payee relationship. Each payee is issued a unique RIN so that only one payer is assigned to a RIN. The RIN is used therefore to determine if the payer is in the CAPC's database.

After the registration code is issued (or the payee is not registered but not a first time payee), method 400 may move to step S440. In step S440, the CAPC disburses the payment to the payee by a paper instrument, such as a check, on behalf of the payer. As is described earlier, the CAPC may also separately send an invitation to the payee to register with the CAPC so that future payments may be made electronically. This invitation to register to the CAPC may include a link to a secure website for registering with the CAPC or other means for registering with the CAPC. The process then may move to step S445 where the payment is now received by the payee and the payee also reviews the invitation to register with the CAPC. The process then may move to step S450 where the payee decides whether to register with the CAPC.

If the payee decides to register with the CAPC, then the method may proceed to step S460; otherwise, the method may proceed to step S455. In step S455, where the payee has decided not to register with the CAPC, the payee will continue to receive checks or other paper payment instruments.

In step S460, where the payee has decided to register with the CAPC, the payee may initiate the registration process. In this manner, the payee provides various information to the CAPC, such as account information, name, address, TIN, and any other information about the payee.

The process then may move to step S465 where the system determines whether the payee's registration code is valid. The payee enters the registration code provided to him by the CAPC in step S437 or S438. The CAPC then retrieves the registration code stored on the CPAC's database. If the retrieved registration code matches the registration code entered by the payee, the registration code is deemed valid. If the registration code is valid, then the method may proceed to step S461. If the registration code is not valid, the method may proceed to step S455.

In S461, in some embodiments, the registration process of the CAPC enables the payee to register custom preferences/instructions, such as the preferred depository account for funds deposit, the preferred remittance detail type (e.g., paper, electronic data interchange (EDI) format, or online image (such as a PDF) for receiving an 835 remittance advice document), the preferred method of payment (e.g., ACH transfer, paper check remittance, credit card based remittance, or other way of receiving payment), routing the remittance detail to the payee's preferred remittance detail destination (e.g., mailing address, the payee's CAPC account, or to a third party such as a clearinghouse or billing agent), and any other preference. As denoted in step S461, information related to the electronic deposit of funds and the preferred format, delivery method and delivery destination of the remittance details is captured within the CAPC. The registration details logged with the CAPC by the payee represent further customization capabilities of the payment and method according to payee preferences. The payer's trading partner relationships with the payee for both the deposit of funds (e.g., electronic funds transfer or EFT) and the delivery of the remittance details are managed by the CAPC.

At step S470, the CAPC activates the payee at the CAPC's database. To do this, the CAPC indicates in the database entry associated with the registered payee that the payee is registered and active. Thus, the next time the RIN of the payee is searched, the payee will be shown as registered and active. Additionally, the payment and remittance preferences and instructions of S461 are saved in the CAPC database along with the other payee data for future retrieval by the CAPC.

Referring back to S408, according to another embodiment, the healthcare payer may submit the payee load file “prior to payment” as mentioned above. In this regard, registration codes can be issued on a periodic basis by the CAPC and is used when the payer expects to make a payment to payee(s) at some point in the future (in anticipation of requiring a future payment rather than a payment being due immediately). Issuing codes prior to payment or a claim enables a pre-emptive enrollment process by which the payer can avoid the need to ever issue a payment in paper form to the payee. To issue registration codes prior to payment, the payer submits a payee load file to the CAPC. Method 400 illustrates this “prior to payment” process proceeds to step S429 instead of S409 from S408.

In response to the CAPC determining that the file is the payee load file from the payer submits, the method may proceed to step S429. In S429, a payee is identified and selected from the payee load file. The payee load file may include a plurality of payees where for each listed payee, the payee load file also includes other information, such as the RIN and payee name and address. Each payee listed in the payee load file is processed separately. For example, for a first payee listed in the payee load file, steps S431 through S470 are performed and such processes are then performed for the second payee and so on until all payees listed in the payee load file are processed.

In step S431, the CAPC determines if an existing registration code has been issued for the selected payee. If there is not an existing registration code for the payee, the method may proceed to step S438 and a “prior payment” registration code is issued for the payee (similar to the process discussed above for S410). The RIN of the selected payee is compared to RINs stored in the CAPC's database to determine if the payee's RIN matches any RINs in the database. If so, the CAPC determines if a registration code has been issued for the payee. Typically, if the payee is in the CAPC's database, a registration code should also have been issued for the payee. If a registration code has been determined to have been issued for the payee, the method 400 may proceeds to step S471; otherwise, the method 400 may proceed to step S438.

In S438, a registration code is issued for the payee by the CAPC and is saved in the CAPC's database in a new entry for the payee. Other information is also stored in the new payee database entry which is included in the payee load file, such as the payee's RIN, TIN, name, address and any other information associated with the selected payee.

In step S471, if the registration code has been issued but remains unregistered, the CAPC conducts campaigns to solicit payee registration. Whenever a payee activates a registration code, the payee is considered “registered” and the CAPC saved the “registered” status in the CAPC's database entry associated with the payee. If the payee is not registered, a field in the payee's database entry indicates that the payee remains unregistered and the method 400 proceeds to S475. Otherwise, if the registration code already exists for the payee on the load file in step S431 and the code has been determined to have been registered at step S471, method 400 may proceed to step S412 whereby payment proceeds as a registered payee as discussed above.

In step S475, the CAPC conducts payee registration solicitation by sending an invitation to the payee to register with the CAPC so that future payments may be made electronically. This invitation to register with the CAPC may include sending a to a secure website for the payee to register with the CAPC, a paper mailing, a phone solicitation, a fax message, a secure email message or other means for registering with the CAPC. If the payee receives the solicitation and chooses to register with the CAPC, the process continues with steps S450-S470, which are discussed above.

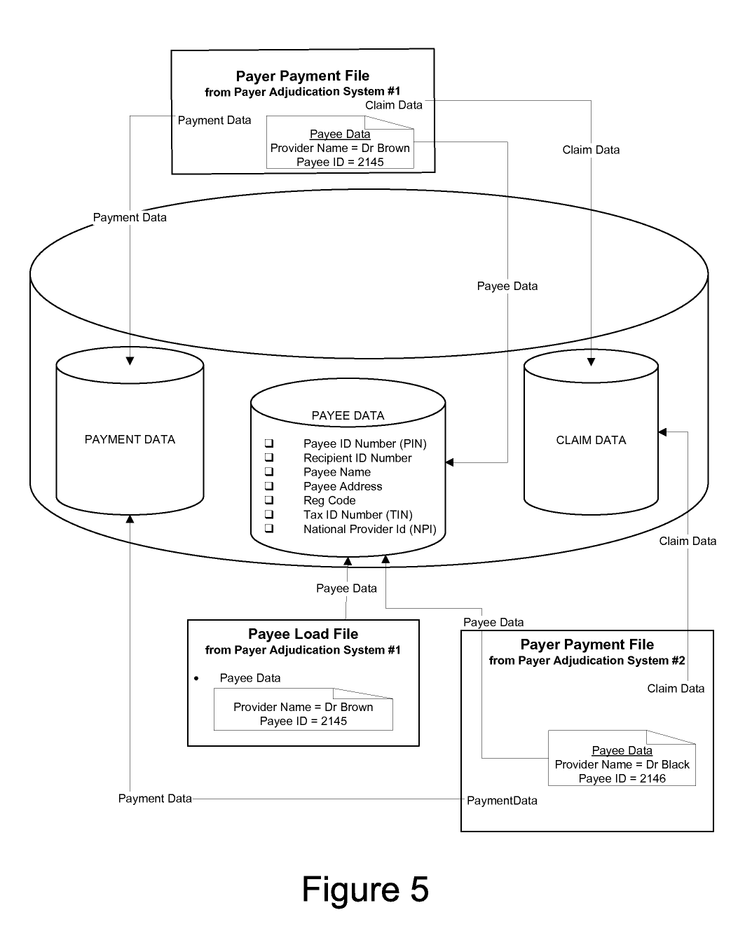

FIG. 5 illustrates a diagrammatic view of a database for housing claim data, payment data and payee data according to one embodiment. FIG. 5 illustrates payers providing payment (via adjudication system #1 and #2) along with a payee providing payee data. All of the data may be stored at the CAPC, and all payments are provided by CAPC to the payee based on the information provided in the payment file(s) from the payer.

As mentioned above, a payer sends a payment file to the CAPC. The payment file may include claim, payee and/or payment information as mentioned above, including the RIN of the payee. When the CAPC receives the payment file, the CAPC parses the file so that the payment data and claim data is placed in separate databases. Payments are made by the CAPC to the payees in accordance with the instructions from the CAPC. The payment data is stored in entries that are associated with respective payee in a payment database, while the claims data is stored in entries that are associated with respective payee in a claims database. Each of these databases may be accessible by the payee, the payer and the CAPC. The CAPC maintains and manages the claims and payments databases.

The CAPC also maintains and manages a payee database. The payee database may include information about all registered and unregistered payees. For each payee, the CAPC stores the payee ID number (PIN), recipient ID number, payee name, payee address, payee registration code, tax ID number, and national provider ID (NPI). These databases may be similar to databases 150 and 250 discussed above. The CAPC uses these databases for registering and identifying payees, as well as making payments and remittances.

The CAPC requires that successive payment sent by a payer to the payee has a consistent value that uniquely identifies the payee. The unique identifiers are referred to herein as the recipient ID number (RIN). Each payment file has the potential to generate new provider registration codes. In this regard, whenever the CAPC encounters a new recipient ID number, the CAPC generates a registration code. Each registration code can be distributed to the payee's at the payer's discretion to enable registration with the CAPC for electronic payments.

Every time a payer sends a payment file for a payee whose RIN already exists in CAPC, current payee data is updated to the values found in the payment. Current payee information that is updated includes payee name, address, tax ID number, PIN, NPI, etc., as mentioned above.

As shown in FIG. 5, the payee load file illustrates a payee uploading data for “prior to payment” registration of a payee. In the example, the payer sends a payee load file that includes Dr. Brown as the payee that the payer requests the CAPC to obtain or maintain registration. Mr. Brown is a health care provider and is allowed to register as mentioned above. After the payee load file is sent to the CAPC, a new database entry for Mr. Brown is created and the payee information is uploaded, including the payee data contained in the payee load file. After Mr. Brown is registered, a payment file for Mr. Brown is shown in FIG. 5 as providing payment to Mr. Brown using the same payee ID. In one embodiment, the payee ID is the same as the RIN.

The foregoing description of the preferred embodiments of the invention has been presented for the purposes of illustration and description. It is not intended to be exhaustive or to limit the invention to the precise form disclosed. Many modifications and variations are possible in light of the above teaching.

1. A method for facilitating automated and secure payment by a customized account processing center (CAPC) between an insurance company and a healthcare provider, comprising:
identifying the health care provider that an insurance company which to make electronic payments via the CAPC;
issuing the health care provider a registration code if the health care provider is not registered with the CAPC and if no registration code have been issued for the health care provider;
soliciting the health care provider to register with the CAPC in response to the registration code being issued but not yet being registered;
determining whether the health care provider chooses to register with CAPC;
receiving and storing registration information from the health care provider in response to the health care provider choosing to register, wherein the registration information comprises account information about the health care provider and the registration code;
authenticating, by a computer at the CAPC, the health care provider by authenticating the existing registration code, on-the-fly registration code or prior payment registration code;
storing the health care provider in the database and activating the health care provider as an electronic payee in response to the successful authentication of the health care provider; and
directing an automated payment to the health care provider based upon pre-determined payee payment rules in response to determining that the health care provider is registered with the CAPC by the health care provider.

2. The method of claim 1, further comprising pre-registering the health care provider prior to an outstanding claim being issued for the insurance company so that the CAPC can make future payments to the health care provider on behalf of the insurance company, comprising:
determining if the registration code has been issued but the health care provider is not registered with the CAPC;
in response to the registration code being issued but the health care provider not being registered with the CAPC, soliciting the health care provider to register; and
in response to the registration code not having been issued, issuing the registration code for the health care provider for the health care provider to pre-register prior to the health care provider providing any claims to the insurance company.

3. The method of claim 1, further comprising:
in response to determining that the health care provider is registered with the CAPC:
creating a record of payments to the health care provider that is accessible to the registered health care provider, the record of payments includes at least one of a record of each payment to the health care provider, an invoice number, a payment amount and a treatment code; and
sending the health care provider a notification that payment was made to the health care provider.

4. The method according to claim 3, wherein the record of payments is accessible to the health care provider, allowing the health care provider to reconcile payments received with outstanding invoices.

5. The method of claim 1, further comprising soliciting registration of the existing registration code or the prior payment registration code in response to determining that a registration code has been issued for the health care provider but the health care provider has not registered.

6. The method of claim 1, further comprising storing information about the health care provider in the database and indicating that the health care provider will receive paper checks in response to determining that the health care provider does not desire to register.

7. The method according to claim 1, wherein the registered health care provider provides at least one of payer account information, payer payments formats or pre-determined payee payment rules.

8. The method according to claim 1, wherein payment is made by the CAPC to the health care provider by paper instrument upon a determination that the health care provider is unregistered.

9. The method according to claim 1, wherein payment is made by the CAPC to the health care provider by paper instrument upon a determination that the health care provider is a first time payee.

10. The method according to claim 1 wherein the insurance company comprises at least one of an insurance service provider, a third party administrator or another health care payer.

11. The method according to claim 1 further comprising:
determining whether an existing registration code has been issued for the health care provider;
wherein the issuing a prior payment registration code for the health care provider is performed in response to determining that the existing registration code for the health care provider has not been issued for the health care provider.

12. A system for automated and secure payment, comprising:
a hardware processor;
a customized account processing engine operable on the processor and including a request for payment module, the request from payment module receiving at least one request for making payment to at least one health care provider;
a registration module operable on the processor and configured for:
identifying a health care provider that an insurance company which to make electronic payments via a customized account processing center (CAPC);
issuing the health care provider a registration code if the health care provider is not registered with the CAPC and if no registration code have been issued for the health care provider;
soliciting the health care provider to register with the CAPC in response to the registration code being issued but not yet being registered;
determining whether the health care provider chooses to register with CAPC;
receiving and storing registration information from the health care provider in response to the health care provider choosing to register, wherein the registration information comprises account information about the health care provider and the registration code;
authenticating the health care provider by authenticating the existing registration code, on-the-fly registration code or prior payment registration code; and
storing the health care provider in the database and activating the health care provider as an electronic payee in response to the successful authentication of the health care provider;
a payment processing module operable on the processor and for facilitating payment to the health care provider based upon the at least one request for making payment, the payment processing module also sending a notification to the health care provider upon payment; and
a records module operable on the processor and for creating a record of all payments to the health care provider.

13. The system according to claim 12, wherein the payment processing module determines whether the health care provider is a registered payee or an unregistered payee.

14. The system according to claim 12, wherein the payment processing module includes at least one of the health care provider's account information, the health care provider's address and the health care provider preferred payment and payment rules.

15. The system according to claim 14, wherein the payment processing module makes payment to the health care provider by a paper instrument upon a determination that the health care provider is an unregistered payee.

16. The system according to claim 14, wherein the payment processing module makes an electronic payment to the payee upon a determination that the health care provider is a registered payee.

17. The system according to claim 12, wherein the records module includes payment details for all insurance companies and payees, including at least one of payment amounts, date of payment, invoice numbers for which payment is being made, a payment amount and a payee treatment code.

18. The system according to claim 12, wherein the records module is accessible to the health care provider to facilitate confirmation of payment amounts and reconciliation of invoices.

19. The system according to claim 12, wherein the registration module is further configured for
pre-registering the health care provider prior to an outstanding claim being due so that the CAPC can make future payments to the health care provider on behalf of the insurance company, comprising:
determining if the registration code has been issued but the health care provider is not registered;
in response to the registration code being issued but the health care provider is not registered, soliciting the health care provider to register; and
in response to the registration code not having been issued, issuing the registration code for the health care provider for the health care provider to pre-register prior to the health care provider providing any claims to the insurance company.
